(19) United States
(12) Patent Application Publication
(10) Pub. No.: US 2009/0100406 A1
(43) Pub. Date: Apr. 16, 2009

(54) Software factory specification and execution model

(75) Inventors: Jack Greenfield, Redmond, WA (US); Mauro Regio, Bellevue, WA (US); Wojtek Kozaczynski, Duvall, WA (US); Thomas J. Hollander, Sydney (AU)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/974,723

(22) Filed: Oct. 16, 2007

(51) Int. Cl. G06F 9/44

(52) U.S. Cl. 717/104

(57) ABSTRACT

A system that facilitates software development by providing a software factory based on an instance of a metamodel. The metamodel supports the definition of one or more viewpoints with a viewpoint comprising one or more work product types, templates for one or more tasks supporting the creation and modification of instances of the viewpoints and work product types, and templates for workstreams comprising one or more tasks and relationships between them. The metamodel supports definition of relationship(s) among viewpoints and/or between viewpoint(s) and work product type(s), and operation(s) that can be performed across relationship(s). Additionally, asset(s), if any, available to particular task(s) can further be defined as supported by the metamodel.

A software factory specification system can be employed by a factory developer to specify an instance of the metamodel which, along with the items described can be employed in an interactive development environment as a software factory.

### BACKGROUND

Software development teams employ domain specific knowledge in order to develop software solutions to real world problems. This domain specific knowledge can include, for example, information regarding business processes, functional and non-functional requirements, business and technical architecture, proven technology choices and implementation decisions, reusable patterns and guidelines, regulatory compliance statements, deployment practices and the like.

Development of software is generally accomplished to acceptable levels of quality. For example, the acceptable levels of quality can include, in addition to functional requirements, conformance to industry standards, manufacturing practices, organizational policies and/or governmental regulations. A development goal can further include embodiment of established methodologies and patterns such that others can understand and maintain the developed software. Additional development goals can include quality attributes, for example, usability, reliability, performance and/or scalability with acceptable levels of resource consumption.

Conventionally, development teams have employed generic tools and platforms to develop software. However, employing these generic tools and platforms has proven frustrating for the development teams as it has been difficult to produce solutions that deliver the required functionality with acceptable quality. Further, using the generic tools and platforms, development teams have been unable to reliably predict budgets and schedules. For example, employment of generic tools and platforms can result in software developed which is over budget and/or is not produced on time. Additionally, the developed software can be of poor quality and/or consistency, have less than optimal traceability, require a significant ramp-up time and/or result in high maintenance costs.

### SUMMARY

The following presents a simplified summary in order to provide a basic understanding of novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed systems and methods facilitate software development by providing a software factory based on an instance of a metamodel (i.e., a model) called a “factory schema” or simply a “schema”. The model defines one or more viewpoints or perspectives with each viewpoint defining views of the software that isolate a specific set of concerns, typically specifying the scope of such a view, the notation(s), if any, used to render it, and the editor(s), if any, used to create and modify it. The model may further define the type(s) of work product(s), if any, produced from each viewpoint, and template(s) for the task(s), if any, executed to produce or maintain each type of view or work product. The model may further define relationship(s) among the viewpoints, as well as relationships between viewpoint(s) and work product types(s), and operation(s) that can be performed across relationship(s). Additionally, the model may describe asset(s), if any, available to support the execution of any task(s) instantiated from the task template(s).

In one implementation, a computer-implemented software factory specification system is provided. The software factory specification system can be employed, for example, by a factory developer to specify a factory schema. The factory schema and the editor(s), task template(s) and asset(s) described collectively form a “software factory”, or simply a “factory” that can capture domain specific knowledge, for example, business processes, requirements, architecture, technology decisions, implementation, patterns and guidelines, regulatory compliance, development constraints, etc. Once implemented, a software factory can be employed, for example, to tailor a general purpose interactive development environment (IDE) to develop a specific kind of software solution.

To the accomplishment of the foregoing and related ends, certain illustrative aspects are described herein in connection with the following description and the annexed drawings. These aspects are indicative, however, of but a few of the various ways in which the principles disclosed herein can be employed. Other advantages and novel features will become apparent from the following detailed description when considered in conjunction with the drawings.

### BRIEF DESCRIPTION OF THE DRAWINGS

FIG. 1 illustrates a computer-implemented software factory specification system.

FIG. 2 illustrates an exemplary factory schema.

FIG. 3 illustrates an exemplary metamodel for factory schemas.

FIG. 4 illustrates a computer-implemented software factory system.

FIG. 5 illustrates an exemplary user interface of an interactive development environment.

FIG. 6 illustrates another exemplary user interface of an interactive development environment.

FIG. 7 illustrates another exemplary user interface of an interactive development environment.

FIG. 8 illustrates a method of specifying a software factory.

FIG. 9 illustrates a method of using a software factory.

FIG. 10 illustrates a computing system operable to execute the disclosed architecture.

FIG. 11 illustrates an exemplary computing environment.

### DETAILED DESCRIPTION

The disclosed systems and methods facilitate software development by providing a software factory based on an instance of a metamodel (i.e., a model), called a “factory schema”, or simply a “schema”. The factory schema captures domain specific knowledge to facilitate building of software solutions to real world problems, defining tasks that can be performed by a software development team to build such solutions, and providing editor(s) and asset(s) that can be used when performing the tasks.

The model defines one or more viewpoints or perspectives with each viewpoint defining views of the software that isolate a specific set of concerns, typically specifying the scope of such a view, the notation(s), if any, used to render the view, and the editor(s), if any, used to create and modify the view. The model may further define the type(s) of work product(s), if any, produced from each viewpoint, and template(s) for the task(s), if any, executed to produce and/or maintain each type of view or work product. The model may further define relationship(s) among the viewpoints, as well as relationships between viewpoint(s) and work product(s), and operation(s) that can be performed across relationship(s). Additionally, the model may describe asset(s), if any, available to support the execution of any task(s) instantiated from the task template(s).

Such a model can be defined, for example, by a factory developer. In one implementation, the model and the editor(s), task template(s) and asset(s) defined can be collectively employed in an interactive development environment by a development team to produce a specific type of product (e.g., client application, mobile client, web service(s), etc.).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof

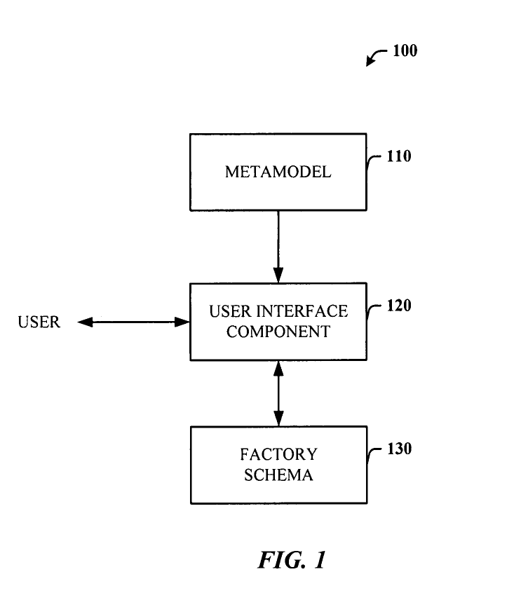

Referring initially to the drawings, FIG. 1 illustrates a computer-implemented software factory specification system 100. The system 100 includes a metamodel 110, a user interface component 120 and a factory schema 130 (i.e., an instance of the metamodel 110). Through the user interface component 120, a user (e.g., a factory developer) can interact with the metamodel 110 to define the factory schema 130 for a particular software factory. In one implementation, the user interface component 120 comprises an interactive development environment.

The factory schema 130 can be employed in an interactive development environment, along with the editor(s), task template(s) and asset(s) described, to support the specification, development, deployment and maintenance of a product (e.g., client application, mobile client, web service(s), etc.). The factory schema 130 and the editor(s), task template(s) and asset(s) described collectively form a “software factory”, or simply a “factory”, that can be employed to improve the productivity of software development team(s) by enabling systematic reuse of software assets that can be applied to produce a wide range of variants of a specific type of software system by exploiting well-defined variability points.

Conventional systems designed to promote the reuse of software assets have been only marginally successful. The metamodel 110 facilitates more effective reuse of software assets by specifying the structure of a factory schema 130 that defines the architectural context(s) in which work products are developed, by placing the process(es) used to develop each work product in the same architectural context(s), and, by providing assets that can be applied to support the enactment of the process(es), for example, within an interactive development environment.

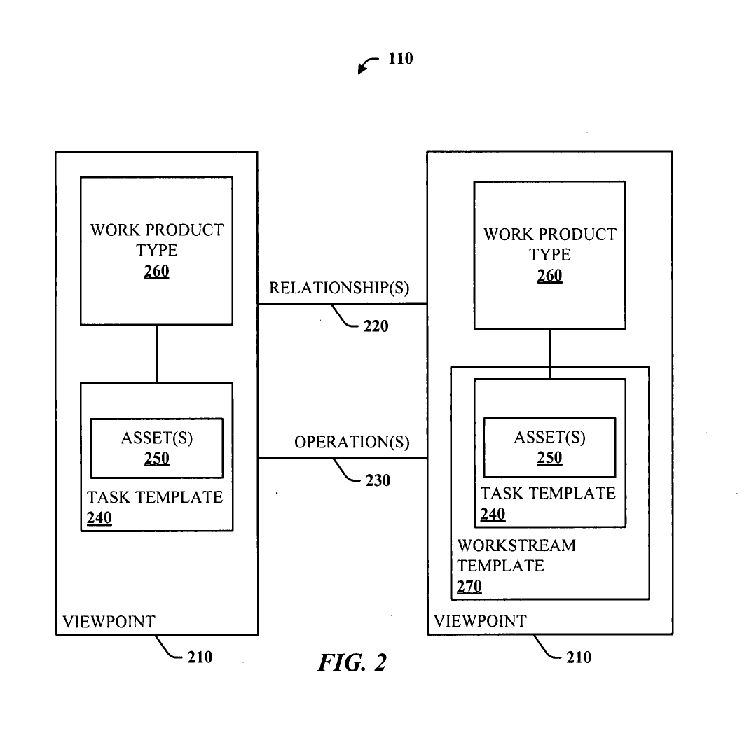

Turning briefly to FIG. 2, the metamodel 110 supports the specification within a factory schema 130 of a set of viewpoints 210. For example, a viewpoint 210 can correspond to a specific aspect of the software under development, representing and isolating concerns of stakeholders in a specific role.

The metamodel 110 further supports the specification within a factory schema 130 of relationship(s) 220 among viewpoints 210 and between viewpoint(s) 210 and work product types(s) 260, and, operation(s) 230 that can be performed across relationships 220. Additionally, the metamodel 110 supports the specification within a factory schema 130 of a set of task templates(s) 240 describing tasks that comprise template(s) 270 for workstream(s) (e.g., custom process(es)) for each viewpoint 210, and, a set of asset(s) 250 (e.g., reusable assets) available to accelerate execution of each instance of a task template 240 (i.e., each task). The metamodel 110 further supports the definition within a factory schema 130 of the type(s) of work product(s) 260 to be consumed and/or produced by each task.

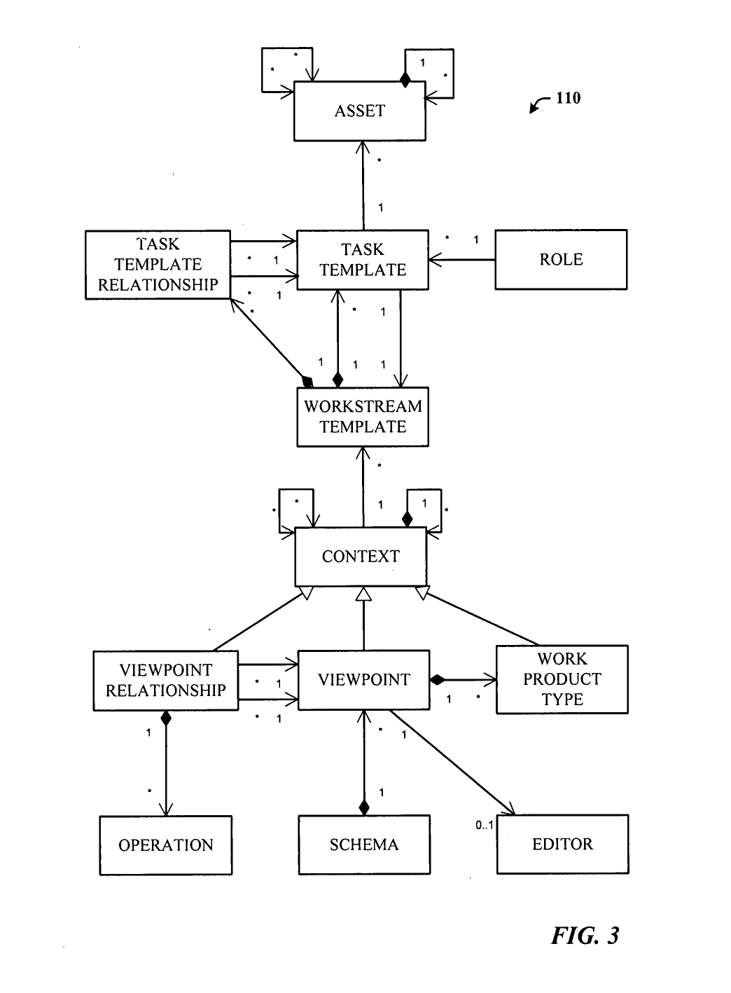

Turning briefly to FIG. 3, an exemplary metamodel 110 is described using the Unified Modeling Language (UML). The metamodel 110 describes the structure of its instances, which are factory schemas 130, by specifying the types of elements (e.g., Asset, Task and Viewpoint) that may appear in a factory schema, and the relationships between them.

Referring to FIGS. 1, 2 and 3, the metamodel 110 provides a structured framework for a factory developer to define viewpoints 210. A viewpoint 210 is a perspective on software to be built. In one example, a viewpoint 210 often maps to an editor.

For each viewpoint 210, the factory developer can specify the type(s) of work product(s) 260 to be produced and define template(s) 240 for task(s) and template(s) 270 for workstream(s) comprised of sets of related tasks (e.g., custom process(es)) for building the specified work product(s) 260. The factory developer can further specify asset(s) 250 (e.g., reusable assets) that support enactment of the task(s) described by the task template(s) 240. The viewpoints 210, relationship(s) 220, operation(s) 230, task template(s) 240 and asset(s) specified, for example, by a factory developer can be described by a factory schema 130. Asset(s) 250 can include, for example, a document, a code template, a script, a pattern, etc.

The factory schema 130, thus, describes viewpoint(s) 210 and template(s) for task(s) 240 that are performed from the particular viewpoint(s) 210 along with asset(s) 250 available to support the performance of the particular task(s) described by the task template(s) 240.

Through the factory schema 130, the factory developer can capture domain specific knowledge regarding business processes, requirements, architecture, technology decisions, implementation, patterns and guidelines, regulatory compliance, development and the like. Using a factory described by such a factory schema 130, a development team can produce software solutions in a structured manner within the architecture specified by the factory developer. Once specified by the factory developer, the factory schema 130 can be employed, along with the editor(s), task template(s) and asset(s) described, for example, in an interactive development environment (IDE) as a software factory, as described in great detail below.

By using the metamodel 110 to specify a factory schema 130, a factory developer can provide a baseline for the development of a software product. Since the factory schema 130 defines a repeatable process, quality and consistency can be predicted more accurately and improved by refining the factory as experience is gained. Additionally, the factory environment can facilitate traceability of software requirements.

For example, the factory schema 130 can enable the software development team to quickly identify work that needs to be accomplished and the best manner in which the work can be accomplished. In one implementation, reusable asset(s) 250 can help the software development team to quickly perform the work that needs to be accomplished.

The structure inherent to the factory schema 130 can result in reduced maintenance costs of the product produced by the software factory. Additionally, changes to the product produced by the software factory can be more readily understood. Further, new member(s) of the software development team can be brought up to speed more quickly.

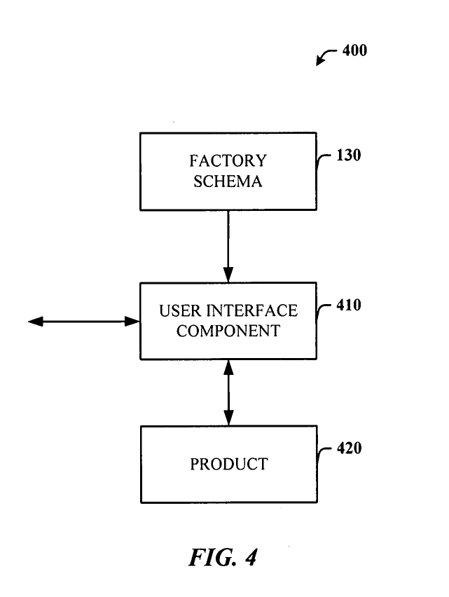

Turning to FIG. 4, a computer-implemented software factory system 400 is illustrated. The system 400 includes a user interface component 410. Through the user interface component 410, user(s) can interact with the factory schema 130, and with the editor(s), task templates(s) and asset(s) described, to create a product 420. “Product” refers to the output of the software factory system 400 and can include software of a known type (e.g., data access layer(s), connected system(s), etc.). Generally, a particular software factory system 400 produces products that are variants of a same type of software (e.g., online banking portal, smart client, mobile client, etc.).

In one implementation, the user interface component 410 is an interactive development environment (IDE). Thus, the software factory system 400 is an extension of the IDE which supplies and supports the application of domain specific knowledge that has been captured in the factory schema 130, for example, by a factory developer, as discussed previously. The factory schema 130 further enables harvesting, production and/or packaging of contextualized manual and/or automated guidance that encapsulates that knowledge and makes the knowledge available to member(s) of a development team and/or their customers.

A user of the system 400 is able to interact with the factory schema 130 via the user interface component 410. The user interface component 410 can expose graphical user interface(s) (GUIs) and/or application program interface(s) (APIs) which interact with the factory schema 130 to assist in creation of the product 420.

The factory schema 130 includes a description of viewpoints 210, a set of work product type(s) 260 associated with particular viewpoints 210, a set of templates for task(s) 240 associated with particular viewpoints and work product type(s) 260, and asset(s) 250 associated with particular task template(s) 240. That is, factory schema 130 describes asset(s) 250 associated with a particular task template 240 associated with a particular viewpoint 210 or work product type 260.

In one implementation, the factory schema 130 allows member(s) of the development team to access one or more views of the product 420 (e.g., the software system under development) corresponding to viewpoints 210 defined in the factory schema 130. The team member(s) can further retrieve and use relationships 220 and operations 230 across viewpoints 210, generate tasks and workstream(s) (i.e., customized processes) from task template(s) 240 and workstream templates 270, and access associated asset(s) 250 for those tasks, in order to evaluate and modify the state of the product 420 under development expressed as a collection of work products (i.e., instances of work product type(s) 260), as an extension to an IDE (e.g., MICROSOFT® VISUAL STUDIO® Team System development environment). Using the factory schema, instances of the viewpoints it describes (i.e., views), and instances of the work product types it describes (i.e., work products) the IDE can facilitate a user's visualization of a structure of the product 420. Using the tasks and workstreams described by the templates supplied by the factory schema, the IDE can further facilitate a user's tracking of progress on parts of the product 420.

The system 400 can support a manner to build a specific type of product 420 as described in the factory schema 130. The factory schema 130 can describe a custom process for building the product 420. Via the user interface component 410, a user can obtain information regarding execution of identified task(s) and asset(s) supporting each task.

In one example, the factory schema 130 describes a core subset of tasks associated with a particular need. That is, the factory schema 130 describes aspects that are common and repeatable across all products 420. In this manner, software development time can be reduced while quality is increased through the employment of reusable assets.

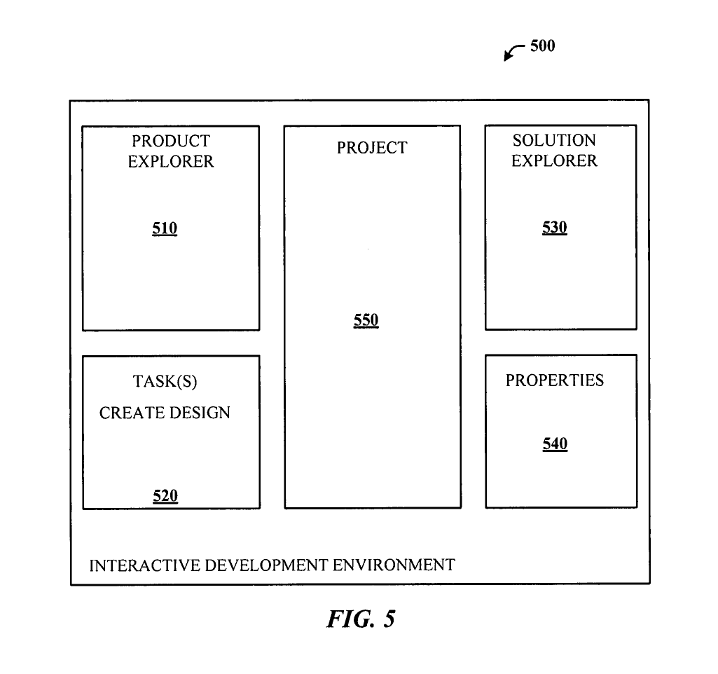

Next, referring to FIG. 5, an exemplary user interface of an interactive development environment 500 that has been configured using a factory schema (e.g., software factory development environment) is illustrated. The user interface 500 includes a product explorer region 510 (e.g., editor region) for displaying products of one or more factories, and viewpoint(s) 210, view(s) and work product(s) associated with a particular product 420. The user interface 500 further includes a task(s) region 520 for displaying task(s) generated from task template(s) 240 and workstream template(s) 270 associated with a particular viewpoint 210 or work product type 260. The user interface 500 further includes a solution explorer region 530, a properties region 540 and a project region 550.

In this example, the user interface 500 provides a platform (e.g., GUIs and APIs) for developing software using the software factory system 400. The user interface 500 provides a graphical representation that can assist user(s) to interact with the software factory system 400 to produce the product 420. In this example, the user can select a single activity “CREATE DESIGN”. Selection of the “CREATE DESIGN” task causes the software factory system 400 to display information as specified in the factory schema 130.

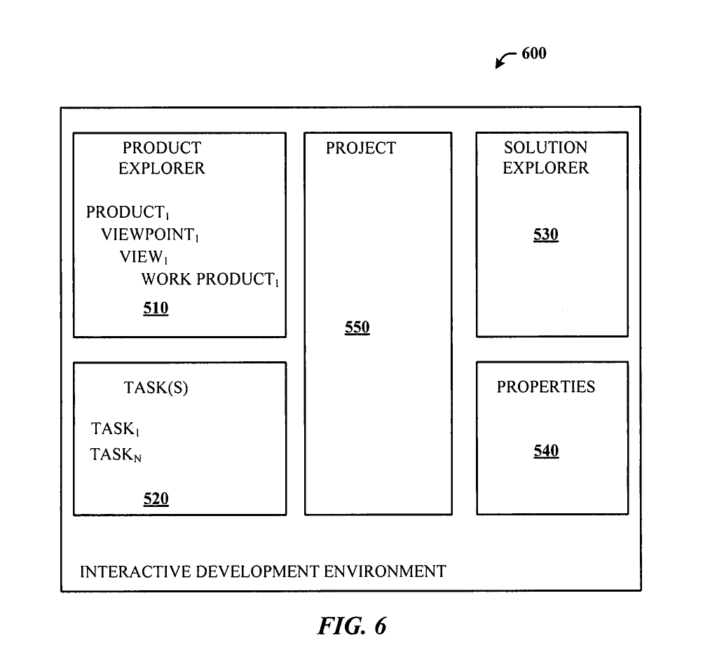

Turning to FIG. 6, an exemplary user interface of an interactive development environment 600 is illustrated. In this example, the user has selected “CREATE DESIGN” in FIG. 5 which has caused “VIEWPOINT₁” to be displayed in the application explorer region 510 and “TASK₁” AND “TASK_{N}” to be displayed in the task(s) region 520 based on the factory schema 130. The user is presented with information (e.g., viewpoints 210, task(s) generated from task template(s) 240 and/or asset(s) 250) as defined by the factory developer in the factory schema 130. Further, one or more flows of the software factory system 400 are described by the factory schema 130.

The user can create view(s) associated with a viewpoint 210. A “view” is a specific description of a specific product 420 under development from a particular viewpoint 210. A view often maps to a specific document opened in a particular editor. A view is associated with a specific product 420 that the software factory system 400 is building. A view also may contain one or more instances of the work product type(s) 260 (i.e., work products) that have been specified in the factory schema 130 in the context of a particular viewpoint 210.

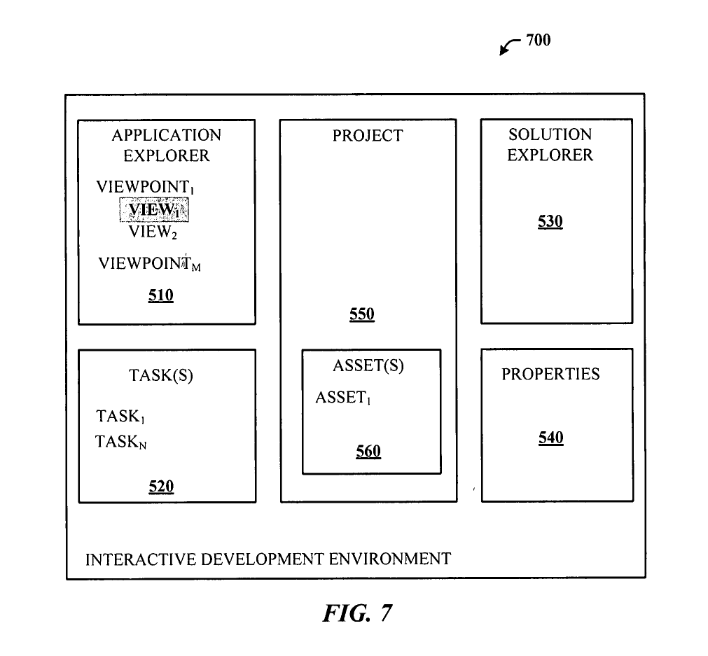

Referring briefly to FIG. 7, an exemplary user interface of an interactive development 700 is illustrated. Continuing with the example of FIGS. 5 and 6, a current focus of the user is “VIEW₁” (e.g., an instance of “VIEWPOINT₁”) and the user has selected “TASK₁” which has caused “ASSET₁” to be displayed in an asset(s) region 560. The asset(s) region 560 describes asset(s) 250, if any, available to a selected task generated from a task template 240. Making specific asset(s) 250 available to the software development team members in the context of a particular viewpoint 210, a particular view conforming to that viewpoint, a particular task that needs to performed as part of the development process, and work product(s) of a particular type 260 that must be produced or maintained, is particularly important to improve software quality, by making the development process more consistent, traceable and predictable, and reducing the training costs for non expert software developers.

In one implementation, the software factory system 400 can capture information associated with the software development experience which can assist in budgeting and scheduling. For example, the system 400 can capture the amount of time a particular task took to complete, the number and skills of user(s) that worked on a particular task, etc.

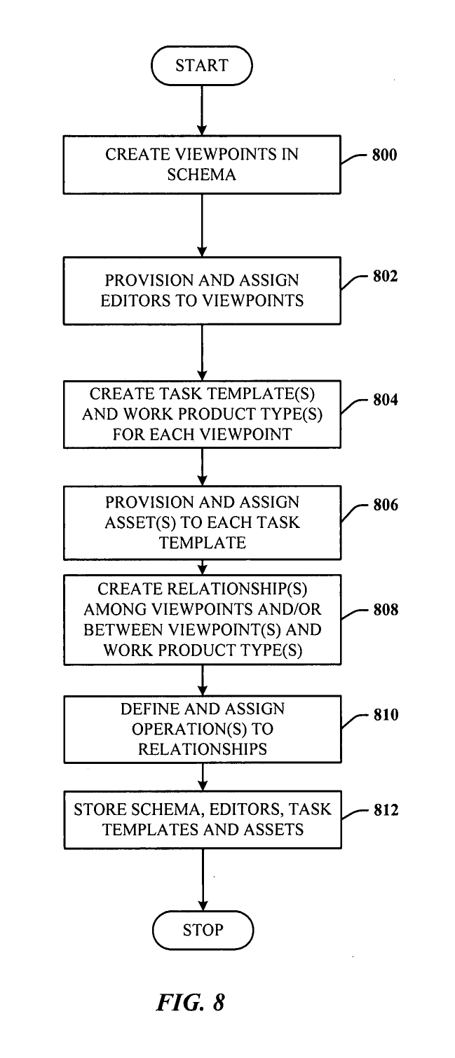

FIG. 8 illustrates a method of specifying a software factory. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 800, viewpoints are created in a factory schema 130, for example, an instance of the metamodel 110. For example, a factory developer can create a factory schema to be employed in an interactive development environment as part of a software factory system 400. The viewpoints created can correspond to specific aspects of software architecture representing and isolating concerns of stakeholders in specific roles.

At 802, editors are provisioned and assigned to viewpoints that require editor(s). Some, all or none of the viewpoints may require editors.

At 804, task templates(s) are created for each viewpoint. The task template(s) can be grouped into workstream template(s) 270 describing workstreams that represent custom process(es) for building instances of the work product type(s) 260 in instance(s) of the particular viewpoint (i.e., view(s)). The work product type(s) 260 are also created in this step.

At 806, asset(s) are provisioned and assigned to each task. The assets can be reusable software assets, for example, document(s), recipes and the like. At 808, relationship(s) are created among viewpoints 210 and/or between viewpoints 210 and work product types 260.

At 810, operation(s) are defined and assigned to relationship(s). At 812, the factory schema 130 and all of the items it describes are stored. The factory schema 130 and the items described by the factory schema 130 can be collectively stored (e.g., to be later employed in an interactive development environment as a software factory).

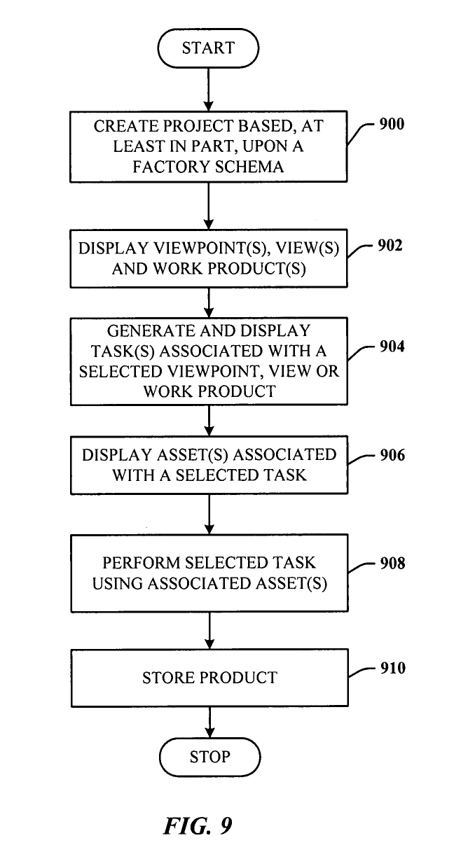

FIG. 9 illustrates a method of using a software factory. At 900, a project is created based, at least in part, upon an instance of the metamodel (i.e., a factory schema 130). At 902, viewpoint(s), view(s) corresponding to the particular viewpoint(s) and work product(s) contained in the particular view(s) are displayed. The viewpoint(s) can correspond to the concerns of factory users working in specific roles associated with the project. Under a particular viewpoint, one or more views can be shown (e.g., as instances of the viewpoint created in the context of the particular project). Under a particular view, one or more work products can be shown (i.e., as instances of the work product types associated with the viewpoint of the particular view).

At 904, task(s) associated with a selected view or work product are generated from template(s), if necessary, and then displayed. For example, the task(s) can be part(s) of workstream(s) that implement custom process(es). Generally, tasks are generated once for a given context (i.e., for a given view or work product), and then displayed each time the context is selected. In one example, values for parameters in the templates can be provided by the context. For example, the name of a task can be taken from the name of the work product with which the task is associated.

At 906, asset(s) associated with a selected task are displayed. At 908, a selected task is performed using the associated asset(s). At 910, the particular product produced using the software factory is stored. The product can be a result of the performing the selected task(s).

While certain ways of displaying information to users are shown and described with respect to certain figures as user interfaces, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

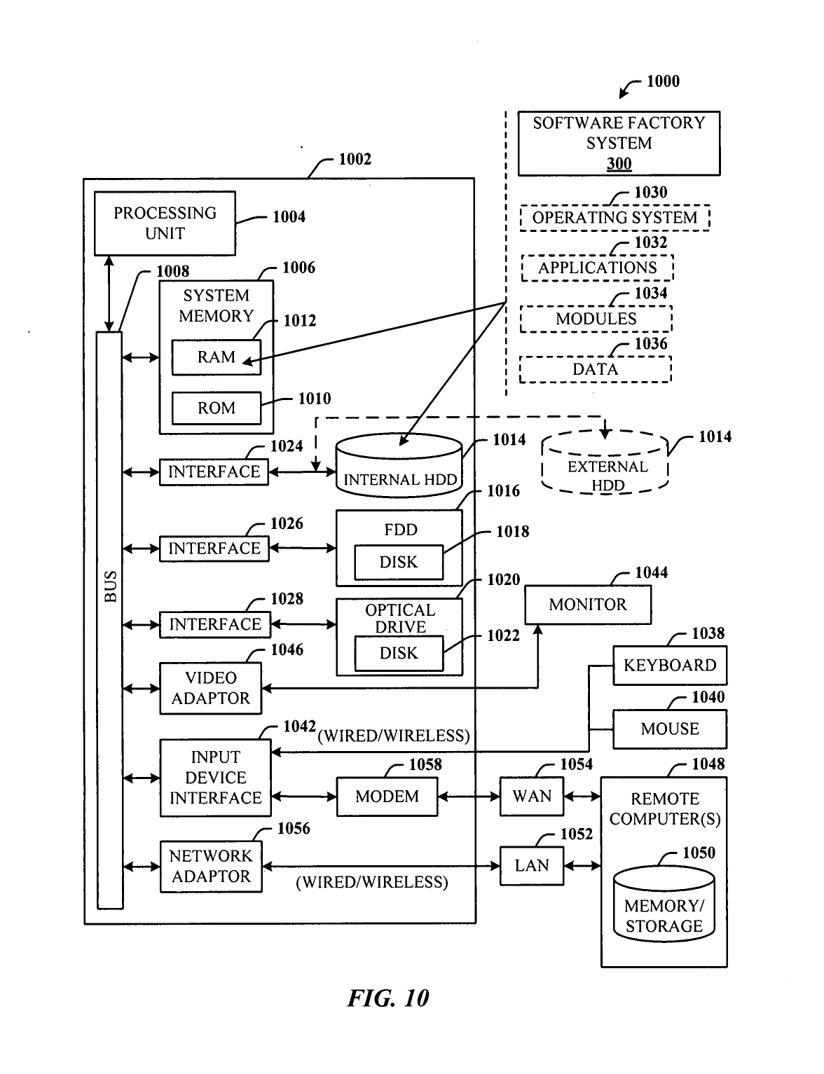

Referring now to FIG. 10, there is illustrated a block diagram of a computing system 1000 operable to execute the disclosed software factory system. In order to provide additional context for various aspects thereof, FIG. 10 and the following discussion are intended to provide a brief, general description of a suitable computing system 1000 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the exemplary computing system 1000 for implementing various aspects includes a computer 1002, the computer 1002 including a processing unit 1004, a system memory 1006 and a system bus 1008. The system bus 1008 provides an interface for system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 1012, including an operating system 1030, one or more application programs 1032, other program modules 1034 and program data 1036. The software factory system 400 can be an application program 1032. All or portions of the operating system, applications, modules, and/or data can also be cached in the RAM 1012. It is to be appreciated that the disclosed architecture can be implemented with various commercially available operating systems or combinations of operating systems.

A user can enter commands and information into the computer 1002 through one or more wired/wireless input devices, for example, a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

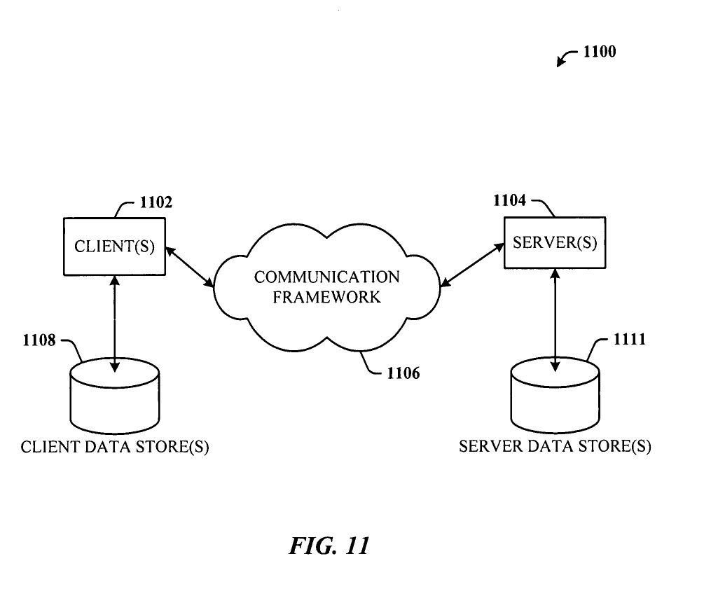

Referring now to FIG. 11, there is illustrated a schematic block diagram of an exemplary computing environment 1100 that facilitates software development via software factory system 400. The system 1100 includes one or more client(s) 1102. The client(s) 1102 can be hardware and/or software (e.g., threads, processes, computing devices). The client(s) 1102 can house cookie(s) and/or associated contextual information, for example.

The system 1100 also includes one or more server(s) 1104. The server(s) 1104 can also be hardware and/or software (e.g., threads, processes, computing devices). The servers 1104 can house threads to perform transformations by employing the architecture, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented software factory specification system, comprising:
a metamodel describing a factory schema, the factory schema comprising a plurality of viewpoints, a viewpoint comprising one or more work product types, each viewpoint or work product type having one or more associated workstream templates, a workstream template comprising task templates and relationships among task templates, each task template describing tasks supporting creation and modification of instances of the viewpoints and work product types, the factory schema further comprising relationships among viewpoints and between a particular viewpoint and a particular work product type, operations that can be performed across relationships among viewpoints, and, zero, one or more assets available to each task template; and,
a user interface component for interacting with the metamodel to specify the factory schema.

2. The system of claim 1, wherein the user interface component comprises an interactive development environment.

3. The system of claim 1, wherein at least one of the assets is a reusable software asset.

4. The system of claim 1, wherein the factory schema further comprises a definition of the types of work products consumed by a particular task.

5. The system of claim 1, wherein the factory schema further comprises a definition of the types of work products to be produced by a particular task.

6. The system of claim 1, wherein the factory schema comprises a particular viewpoint that maps to a designer.

7. The system of claim 1, wherein the factory schema is a schema for a software factory system.

8. The system of claim 1, wherein each task template is part of a workstream template describing a workstream that comprises a custom process.

9. The system of claim 1, wherein the factory schema comprises a description of assets available to each task template.

10. A computer-implemented software factory system, comprising:
a factory schema that comprises a plurality of viewpoints, a viewpoint comprising one or more work product types, each viewpoint or work product type having one or more associated workstream templates, a workstream template comprising task templates and relationships among task templates, each task template describing tasks supporting creation and modification of instances of the viewpoints and work product types, the factory schema further defining relationships among viewpoints and between a particular viewpoint and a particular work product type, operations that can be performed across relationships among viewpoints, and, zero, one or more assets available to each task template; and,
a user interface component for interacting with the factory schema to produce a product.

11. The system of claim 10, wherein interacting with the factory schema comprises retrieving and using a particular relationship between at least two particular viewpoints.

12. The system of claim 10, wherein interacting with the factory schema comprises retrieving and using an operation associated with a particular relationship among viewpoints.

13. The system of claim 10, wherein interacting with the factory schema comprises at least one of accessing one or more tasks generated from task and/or workstream templates associated with a selected viewpoint or work product instance, or accessing an asset associated with a selected task.

14. The system of claim 10, wherein the user interface component comprises an interactive development environment.

15. The system of claim 10, wherein the user interface component comprises a user interface displaying at least one of viewpoints, views, work products, workstreams or tasks associated with a selected view or work product.

16. The system of claim 15, wherein the user interface further displays zero, one or more assets associated with a selected task.

17. A computer-implemented method of using a software factory, comprising:
creating a project based, at least in part, upon a factory schema, the factory schema comprising a plurality of viewpoints, a viewpoint comprising one or more work product types, each viewpoint or work product type having one or more associated workstream templates, a workstream template comprising task templates and relationships among task templates, each task template describing tasks supporting creation and modification of instances of the viewpoints and work product types, the factory schema further defining relationships among viewpoints and between a particular viewpoint and a particular work product type, operations that can be performed across relationships among viewpoints, and, zero, one or more assets available to each task template;
displaying the plurality of viewpoints, instances of the plurality of viewpoints, and the work products contained by the instances of the plurality of viewpoints; and,
displaying at least one task associated with a selected view or work product.

18. The method of claim 17, further comprising displaying at least one asset associated with a selected task.

19. The method of claim 18, further comprising using the selected asset to perform a selected task.

20. The method of claim 19, further comprising storing a product that is a result of performing one or more of the selected tasks.
